(19) United States
(12) Patent Application Publication
(10) Pub. No.: US 2024/0118301 A1
(43) Pub. Date: Apr. 11, 2024

(54) REAGENT STORING SYSTEM, AUTOMATIC ANALYZING SYSTEM, AND PREVENTING MEMBER

(71) Applicant: CANON MEDICAL SYSTEMS CORPORATION, Tochigi (JP)

(72) Inventor: Shin IIDA, Ota (JP)

(73) Assignee: CANON MEDICAL SYSTEMS CORPORATION, Tochigi (JP)

(21) Appl. No.: 18/482,055

(22) Filed: Oct. 6, 2023

(30) Foreign Application Priority Data
Oct. 7, 2022 (JP) 2022-162332

(51) Int. Cl. G01N 35/04; G01N 35/00; G01N 35/10

(52) U.S. Cl. CPC G01N 35/04; G01N 35/00732; G01N 35/1002; G01N 2035/00445; G01N 2035/00792; G01N 2035/0443

(57) ABSTRACT

A reagent storing system according to an embodiment includes: a reagent storage including a rotating table on which a reagent container is placed, a casing formed to be able to house the rotating table therein, a cover configured to cover an opening of the casing, a cooling unit, a fan configured to circulate air in the casing so that the inside of the casing is cooled by the cooling unit, and a partition part configured to partition a space formed by the cover and the casing into a space in which an opening part of the reagent container is present and a space in which a main body of the reagent container is present; and a preventing member configured, while being placed in a location where the reagent container is not placed, to prevent the air from flowing in to the opening part of the reagent container through the location.

### CROSS-REFERENCE TO RELATED APPLICATIONS

This application is based upon and claims the benefit of priority from Japanese Patent Application No. 2022-162332, filed on Oct. 7, 2022; the entire contents of which are incorporated herein by reference.

### FIELD

Embodiments described herein relate generally to a reagent storing system, an automatic analyzing system, and a preventing member.

### BACKGROUND

In an automatic analyzing apparatus for a clinical test, a biological specimen (hereinafter, “specimen”) such as blood or urine and a reagent, each in a prescribed amount, are mixed together to cause a reaction therebetween, so that the amount of transmitted light or scattered light obtained by emitting light onto the liquid mixture is measured. In this manner, the automatic analyzing apparatus is configured to calculate the density and an activity value of a substance subject to the measuring process, as well as a time required by a change, and the like. The reagent is contained in a reagent container and is kept cold in a reagent storage provided for an automatic analyzing system. The reagent kept cold in the reagent storage is aspirated out of the reagent container by a reagent dispensing probe with timing based on the measuring process and is dispensed into a reaction container.

In the reagent storage, cooled air is circulated so as to efficiently maintain the temperature in the reagent storage low. For this reason, there is a possibility that the reagent contained in the reagent container may evaporate in the reagent storage. To cope with this situation, in order to prevent the reagent in the reagent storage from evaporating, for example, a possible method is to provide the reagent container with a reagent evaporation preventing mechanism such as an automatic open/close cap or a convenient piercing element. However, if the reagent container were provided with such a reagent evaporation preventing mechanism, the structure of the automatic analyzing system that drives the reagent evaporation preventing mechanism would become complicated.

### BRIEF DESCRIPTION OF THE DRAWINGS

FIG. 1 is a block diagram illustrating an exemplary configuration of an automatic analyzing system to which a reagent storing system according to an embodiment of the present disclosure is applied;

FIG. 2 is a perspective view illustrating an exemplary configuration of an analyzing apparatus in the automatic analyzing system in FIG. 1;

FIG. 3 is a schematic drawing illustrating an exemplary configuration of a reagent storage in the reagent storing system of the present embodiment and presents a cross-sectional view of the reagent storage;

FIG. 4 is another schematic drawing illustrating the exemplary configuration of the reagent storage in the reagent storing system of the present embodiment and presents a top view cross-sectioned at X-X in FIG. 3;

FIG. 5 is a drawing illustrating an example of a circulation path for air in the reagent storage in FIG. 3;

FIG. 6A is a schematic drawing illustrating an example of a vacant position cap in the reagent storing system according to the present embodiment and presents a perspective view of the vacant position cap;

FIG. 6B is another schematic drawing illustrating the example of the vacant position cap in the reagent storing system according to the present embodiment and presents a cross-sectional view of the vacant position cap;

FIG. 7 is a flowchart illustrating a process performed for preventing air from flowing in through a vacant position, in the automatic analyzing system to which the reagent storing system according to the present embodiment is applied;

FIG. 8 is a perspective view illustrating an exemplary configuration of a tray in a reagent storage and examples of vacant position caps in a first modification example;

FIG. 9 is a schematic drawing illustrating another example of a vacant position cap in a second modification example;

FIG. 10A is a schematic drawing illustrating an exemplary configuration for preventing air from flowing in through a vacant position in a third modification example;

FIG. 10B is another schematic drawing illustrating the exemplary configuration for preventing air from flowing in through the vacant position in the third modification example; and

FIG. 10C is yet another schematic drawing illustrating the exemplary configuration for preventing air from flowing in through the vacant position in the third modification example.

### DETAILED DESCRIPTION

A reagent storing system according to an embodiment of the present disclosure includes a reagent storage and a preventing member. The reagent storage includes a rotating table, a casing, a cover, a cooling unit, a fan, and a partition part. On the rotating table, a reagent container is placed. The casing is formed to be able to house the rotating table therein. The cover is configured to cover an opening of the casing. The fan is configured to circulate air in the casing so that the inside of the casing is cooled by the cooling unit. The partition part is configured to partition a space formed by the cover and the casing into a space in which an opening part of the reagent container is present and a space in which a main body of the reagent container is present. While being placed in a location where the reagent container is not placed, the preventing member is configured to prevent the air from flowing in to the opening part of the reagent container through the location.

Exemplary embodiments of a reagent storing system, an automatic analyzing system, and a preventing member will be explained in detail below, with reference to the accompanying drawings. Possible embodiments are not limited to the embodiments described below. Further, the description of each of the embodiments is, in principle, similarly applicable to any other embodiment.

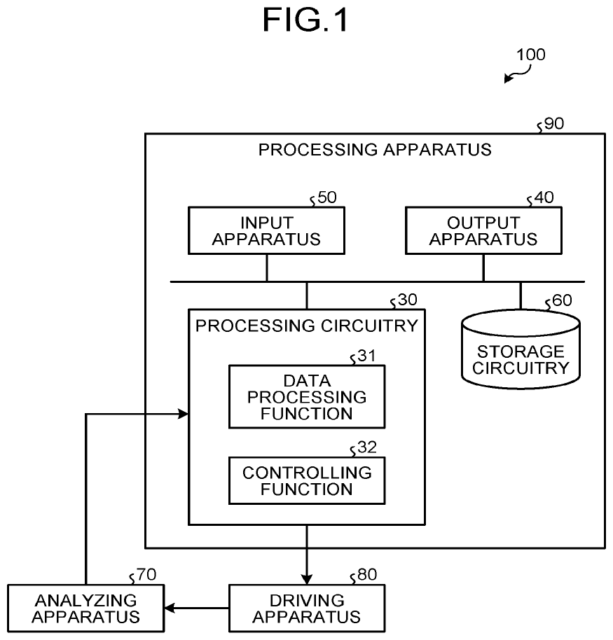

FIG. 1 is a block diagram illustrating an exemplary configuration of an automatic analyzing system 100 to which a reagent storing system according to an embodiment of the present disclosure is applied. The automatic analyzing system 100 illustrated in FIG. 1 includes an analyzing apparatus 70, a driving apparatus 80, and a processing apparatus 90.

The analyzing apparatus 70 is configured to generate standard data and test data, by performing a measuring process on a liquid mixture in which a standard specimen of each test item or a test specimen (a biological specimen such as blood or urine) collected from an examined subject (a patient) is mixed with a reagent used in an analysis of each test items. The analyzing apparatus 70 includes a plurality of units configured to dispense the specimen, to dispense the reagent, and the like. The driving apparatus 80 is configured to drive the units in the analyzing apparatus 70. The processing apparatus 90 is configured to control the driving apparatus 80 so as to bring the units in the analyzing apparatus 70 into operation.

The processing apparatus 90 includes an input apparatus 50, an output apparatus 40, processing circuitry 30, and storage circuitry 60.

The input apparatus 50 includes input mechanisms such as a keyboard, a mouse, a button, a touch key panel, and/or the like and is configured to receive an input for setting an analysis parameter of each test item, to receive an input for setting test identification information and test items of the test specimen.

The output apparatus 40 includes a printer and a display. The printer is configured to print data generated by the processing circuitry 30. The display is a monitor such as a Cathode Ray Tube (CRT) or a liquid crystal panel and is configured to display the data generated by the processing circuitry 30. In the present example, the output apparatus 40 is an example of the “output unit”.

The storage circuitry 60 may be a semiconductor memory element such as a Random Access Memory (RAM) or a flash memory or a storage apparatus such as a hard disk or an optical disk, for example.

The processing circuitry 30 is configured to control the entirety of the system. For example, as illustrated in FIG. 1, the processing circuitry 30 is configured to execute a data processing function 31 and a controlling function 32. The controlling function 32 is configured to control the driving apparatus 80 so as to bring the units in the analyzing apparatus 70 into operation. In the present example, the controlling function 32 is an example of a controlling unit. The data processing function 31 is configured to generate calibration data or analysis data of each test item, by processing the standard data or the test data generated by the analyzing apparatus 70. In the present example, the controlling function 32 is an example of the “controlling unit”.

For example, the standard data generated by the analyzing apparatus 70 denotes data (a calibration curve or a standard curve) for determining an amount or a density of a substance. The test data generated by the analyzing apparatus 70 denotes data of a result of the measuring process performed on the test specimen. Further, the calibration data output from the processing circuitry 30 denotes data indicating a result of the measuring process such as an amount or a density of the substance derived from the test data and the standard data. The analysis data output from the processing circuitry 30 denotes data indicating a judgment result being positive or negative. In other words, the calibration data is data for deriving the analysis data indicating the judgment result being positive or negative.

In this situation, for example, the processing functions executed by constituent elements of the processing circuitry 30 are recorded in the storage circuitry 60 in the form of computer-executable programs. The processing circuitry 30 is a processor configured to realize the functions corresponding to the programs by reading and executing the programs from the storage circuitry 60. In other words, the processing circuitry 30 that has read the programs has the functions illustrated within the processing circuitry 30 in FIG. 1.

Further, although FIG. 1 illustrates the example in which the single piece of controlling circuitry (i.e., the processing circuitry 30) realizes the processing functions described below, another example is also acceptable in which processing circuitry is structured by combining together a plurality of independent processors, so that the functions are realized as a result of the processors executing the programs.

The term “processor” used in the above explanation denotes, for example, a Central Processing Unit (CPU), a Graphics Processing Unit (GPU), or circuitry such as an Application Specific Integrated Circuit (ASIC) or a programmable logic device (e.g., a Simple Programmable Logic Device (SPLD), a Complex Programmable Logic Device (CPLD), or a Field Programmable Gate Array (FPGA)). When the processor is a CPU, for example, one or more processors are configured to realize the functions by reading and executing the programs saved in the storage circuitry 60. In contrast, when the processor is an ASIC, for example, instead of having the programs saved in the storage circuitry 60, the programs are directly incorporated in the circuitry of one or more processors. The processors in the present embodiment do not each necessarily have to be structured as a single piece of circuitry. It is also acceptable to structure one processor by combining together a plurality of pieces of independent circuitry so as to realize the functions thereof. Further, it is also acceptable to integrate two or more of the constituent elements illustrated in FIG. 1 into one processor so as to realize the functions thereof.

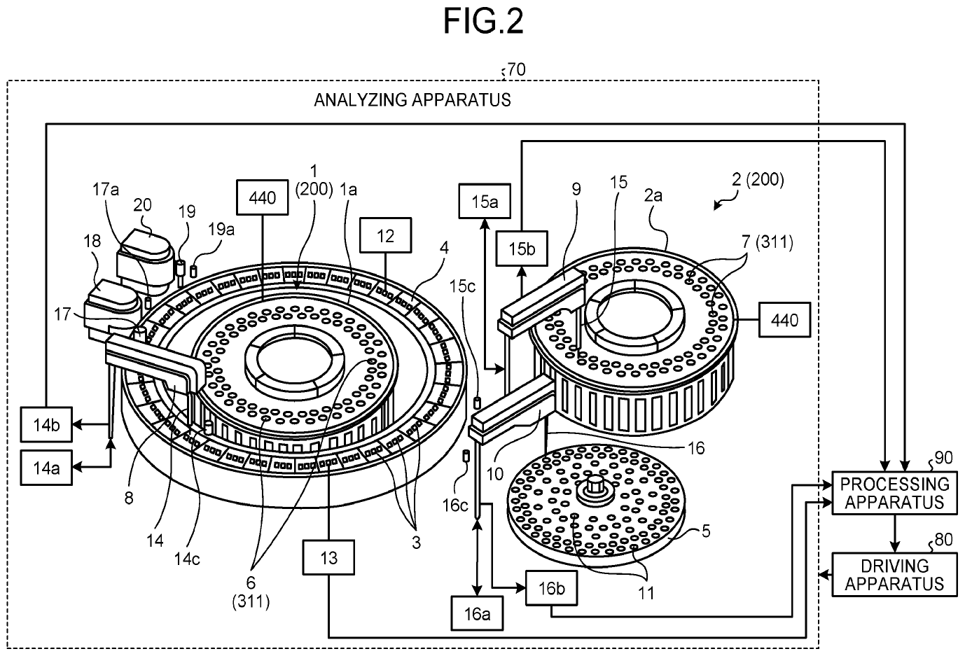

FIG. 2 is a perspective view illustrating an exemplary configuration of the analyzing apparatus 70 in the automatic analyzing system 100 in FIG. 1.

The analyzing apparatus 70 includes a sample disc 5 holding a plurality of specimen containers 11. The specimen containers 11 contain the standard specimen of each test item and specimens such as test specimens.

The analyzing apparatus 70 further includes a plurality of reagent containers 6, a reagent storage 1 storing therein the plurality of reagent containers 6, a plurality of reagent containers 7, and a reagent storage 2 storing therein the plurality of reagent containers 7. The reagent containers 6 and 7 each contain a reagent including a component that reacts with a component of each test item contained in a specimen. The reagent storage 1 includes a reagent rack 1a realized with a turn table configured to rotatably hold the reagent containers 6 corresponding to the test items. The reagent storage 2 includes a reagent rack 2a realized with a turn table configured to rotatably hold the reagent containers 7 corresponding to the test items.

The analyzing apparatus 70 further includes a plurality of reaction containers 3 arranged on a circumference and a reaction disc 4 configured to rotatably and movably hold each of the plurality of reaction containers 3.

The analyzing apparatus 70 further includes a specimen dispensing probe 16, a specimen dispensing arm 10, a specimen dispensing pump unit 16a, a specimen detector 16b, and a cleaning tank 16c. The specimen dispensing probe 16 is configured to dispense the specimen. More specifically, the specimen dispensing probe 16 is configured to aspirate the specimen from any of the specimen containers 11 held on the sample disc 5 with respect to each test item and to dispense the specimen in an amount set as an analysis parameter of the test item into one of the reaction containers 3. The specimen dispensing arm 10 is configured to support the specimen dispensing probe 16 so as to be rotatable and vertically movable. The specimen dispensing pump unit 16a is configured to cause the specimen dispensing probe 16 to aspirate and to dispense the specimen. The specimen detector 16b is configured to determine that the specimen in any of the specimen containers 11 is detected, when a tip end part of the specimen dispensing probe 16 descending from above the liquid surface of the specimen in the specimen container 11 held on the sample disc 5 comes into contact with the liquid surface. More specifically, the specimen detector 16b is electrically connected to the specimen dispensing probe 16 and is configured to detect the liquid surface of the specimen in any of the specimen containers 11, on the basis of a change in capacitance caused when the tip end part of the specimen dispensing probe 16 comes into contact with the specimen in the specimen container 11. When the liquid surface of the specimen in any of the specimen containers 11 is detected, the specimen dispensing pump unit 16a is configured to cause the specimen dispensing probe 16 to aspirate and to dispense the specimen. The cleaning tank 16c is configured to clean the specimen dispensing probe 16 every time the dispensing of the specimen is finished.

The analyzing apparatus 70 further includes a reagent dispensing probe 14, a reagent dispensing arm 8, a reagent dispensing pump unit 14a, a reagent detector 14b, a cleaning tank 14c, an agitator 17, an agitating arm 18, and a cleaning tank 17a. The reagent dispensing probe 14 is configured to dispense the reagent in any of the reagent containers 6. More specifically, the reagent dispensing probe 14 is configured to aspirate the reagent out of any of the reagent containers 6 corresponding to each test item and being held on the reagent rack 1a and to dispense the reagent in an amount set as an analysis parameter of the test item into one of the reaction containers 3 in which the specimen was dispensed. The reagent dispensing arm 8 is configured to support the reagent dispensing probe 14 so as to be rotatable and vertically movable. The reagent dispensing pump unit 14a is configured to cause the reagent dispensing probe 14 to aspirate and to dispense the reagent. As a liquid surface detecting function, the reagent detector 14b is configured to determine that the reagent in any of the reagent containers 6 is detected, when a tip end part of the reagent dispensing probe 14 descending from above the liquid surface of the reagent in the reagent container 6 held on the reagent rack 1a comes into contact with the liquid surface. More specifically, the reagent detector 14b is electrically connected to the reagent dispensing probe 14 and is configured to detect the liquid surface of the reagent in any of the reagent containers 6, on the basis of a change in capacitance caused when the tip end part of the reagent dispensing probe 14 comes into contact with the reagent in the reagent container 6. When the liquid surface of the reagent in any of the reagent containers 6 is detected, the reagent dispensing pump unit 14a is configured to cause the reagent dispensing probe 14 to aspirate and to dispense the reagent. The cleaning tank 14c is configured to clean the reagent dispensing probe 14 every time the reagent has been dispensed. The agitator 17 is configured to agitate a liquid mixture of the specimen and the reagent that was dispensed in any of the reaction containers 3. The agitating arm 18 is configured to support the agitator 17 so as to be rotatable and vertically movable. The cleaning tank 17a is configured to clean the agitator 17 every time the liquid mixture has been agitated.

The analyzing apparatus 70 further includes a reagent dispensing probe 15, a reagent dispensing arm 9, a reagent dispensing pump unit 15a, a reagent detector 15b, a cleaning tank 15c, an agitator 19, an agitating arm 20, and a cleaning tank 19a. The reagent dispensing probe 15 is configured to dispense the reagent in any of the reagent containers 7. In this situation, because the functions of the reagent dispensing probe 15, the reagent dispensing arm 9, the reagent dispensing pump unit 15a, the reagent detector 15b, the cleaning tank 15c, the agitator 19, the agitating arm 20, and the cleaning tank 19a are the same as the functions of the reagent dispensing probe 14, the reagent dispensing arm 8, the reagent dispensing pump unit 14a, the reagent detector 14b, the cleaning tank 14c, the agitator 17, the agitating arm 18, and the cleaning tank 17a, respectively, explanations thereof will be omitted.

The analyzing apparatus 70 further includes a measuring unit 13 and a reaction container cleaning unit 12. The measuring unit 13 is configured to perform a measuring process on the liquid mixture by emitting light onto any of the reaction containers 3 containing the liquid mixture agitated by the agitator 17 or any of the reaction containers 3 containing the liquid mixture agitated by the agitator 19. More specifically, the measuring unit 13 is configured to emit the light onto one of the reaction containers 3 that has been rotated and moved into a measuring position and to thus detect light that has transmitted, due to the emission, through the liquid mixture of the specimen and the reagent in the reaction container 3. After that, the measuring unit 13 is configured to generate the standard data or the test data expressed as a digital signal, by processing a detected signal, and to further output the generated data to the processing circuitry 30 of the processing apparatus 90. The reaction container cleaning unit 12 is configured to clean the inside of the reaction container 3 on which the measuring process by the measuring unit 13 has been finished.

The driving apparatus 80 is configured to drive the units in the analyzing apparatus 70.

The driving apparatus 80 includes a mechanism configured to drive the sample disc 5 of the analyzing apparatus 70 and is configured to rotate and move the specimen containers 11. Further, the driving apparatus 80 includes a mechanism configured to drive the reagent rack 1a of the reagent storage 1 and is configured to rotate and move the reagent containers 6. In addition, the driving apparatus 80 includes a mechanism configured to drive the reagent rack 2a of the reagent storage 2 and is configured to rotate and move the reagent containers 7. Furthermore, the driving apparatus 80 includes a mechanism configured to drive the reaction disc 4 and is configured to rotate and move the reaction containers 3.

Further, the driving apparatus 80 includes a mechanism configured to rotate and vertically move the specimen dispensing arm 10 and is configured to move the specimen dispensing probe 16 between the specimen containers 11 and the reaction containers 3. Further, the driving apparatus 80 includes a mechanism configured to drive the specimen dispensing pump unit 16a and is configured to cause the specimen dispensing probe 16 to dispense the specimen. In other words, the specimen dispensing probe 16 is caused to aspirate the specimen out of any of the specimen containers 11 and to dispense the specimen into any of the reaction containers 3.

Further, the driving apparatus 80 includes a mechanism configured to rotate and vertically move the reagent dispensing arms 8 and 9 and is configured to move the reagent dispensing probes 14 and 15 between the reagent containers 6, 7, and the reaction containers 3, respectively. Also, the driving apparatus 80 includes a mechanism configured to drive the reagent dispensing pump units 14a and 15a and is configured to cause the reagent dispensing probes 14 and 15 to dispense the reagent. In other words, the reagent dispensing probes 14 and 15 are caused to aspirate the reagent out of the reagent containers 6 and 7 and to dispense the reagent into any of the reaction containers 3. Furthermore, the driving apparatus 80 includes a mechanism configured to drive the agitating arms 18 and 20 and is configured to move the agitators 17 and 19 to the inside of any of the reaction containers 3. In addition, the driving apparatus 80 includes a mechanism configured to drive the agitators 17 and 19 and is configured to cause the specimen and the reagent in any of the reaction containers 3 to be agitated.

The controlling function 32 of the processing apparatus 90 is configured to control the driving apparatus 80 so as to bring the units in the analyzing apparatus 70 into operation.

An overall configuration of the automatic analyzing system 100 to which the reagent storing system of the present embodiment is applied has thus been explained. The reagent storing system according to the present embodiment structured as described above is configured to prevent the reagent in the reagent storage from evaporating, by using a simple structure as described below.

In the reagent storage, cooled air is circulated so as to efficiently maintain the temperature in the reagent storage low. For this reason, there is a possibility that the reagent contained in the reagent container may evaporate in the reagent storage. To cope with this situation, in order to prevent the reagent in the reagent storage from evaporating, for example, a possible method is to provide the reagent container with a reagent evaporation preventing mechanism such as an automatic open/close cap or a convenient piercing element. However, this method would complicate the structure of the automatic analyzing system that drives the reagent evaporation preventing mechanism.

To avoid this problem, a reagent storing system according to the present embodiment includes the reagent storage and the preventing member. The reagent storage includes a rotating table, a casing, a cover, a cooling unit, a fan, and a partition part. On the rotating table, the reagent containers are placed. The casing is formed to be able to house the rotating table therein. The cover is configured to cover an opening of the casing. The fan is configured to circulate the air in the casing so that the inside of the casing is cooled by the cooling unit. The partition part is configured to partition the space formed by the cover and the casing into a space in which an opening part of the reagent container is present and a space in which a main body of the reagent container is present. The preventing member is placed in a location where no reagent container is placed and is configured to prevent air from flowing in to the opening part of the reagent container through the location.

As explained above, the reagent storing system according to the present embodiment is provided with the partition part configured to partition the space formed by the cover and the casing into the space in which the opening part of the reagent container is present and the space in which the main body of the reagent container is present, so that air is thereby prevented from flowing in to the opening part of the reagent container. Further, in the reagent storing system according to the present embodiment, by placing the preventing member in the location where no reagent container is placed, air is prevented from flowing in to the opening part of the reagent container through the location. With these arrangements, the reagent storing system according to the present embodiment is able to prevent the reagent in the reagent storage from evaporating, by using the simple structure.

In the present example, a system obtained by applying the preventing member (a vacant position cap explained later) to an apparatus (an automatic analyzing apparatus) including the analyzing apparatus 70, the driving apparatus 80, and the processing apparatus 90 illustrated in FIG. 2 will be referred to as the automatic analyzing system 100. Further, a system obtained by applying the preventing member (the vacant position cap explained later) is applied to the reagent storages 1 and 2 illustrated in FIG. 2 will be referred to as a reagent storing system.

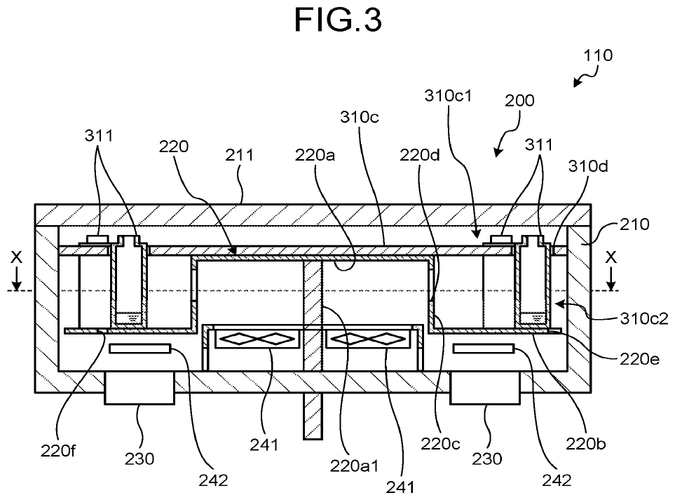

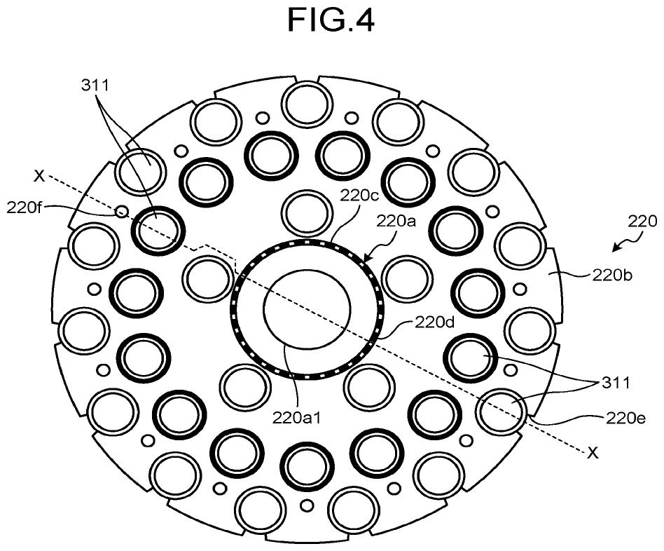

The abovementioned reagent storing system will be explained with reference to FIGS. 3 and 4 and others. In FIGS. 3 and 4, the reagent storages 1 and 2 in FIG. 2 having mutually the same configuration are illustrated as a reagent storage 200. Further, in FIGS. 3 and 4, the reagent containers 6 and 7 in FIG. 2 having mutually the same configuration are illustrated as reagent containers 311.

At first, the reagent storage 200 in which the reagent containers 311 are kept cold will be explained in detail. FIGS. 3 and 4 are schematic drawings illustrating an exemplary configuration of the reagent storage 200 in a reagent storing system 110 according to the present embodiment. FIG. 3 is a cross-sectional view of the reagent storage 200. FIG. 4 is a top view cross-sectioned at X-X in FIG. 3.

As illustrated in FIG. 3, the reagent storing system 110 according to the present embodiment includes the reagent storage 200 and the reagent containers 311.

The reagent storage 200 includes a casing 210, a reagent cover 211, a rotating table 220, a cooling element 230, fans 241 and 242, and a convection partition plate 310c. The rotating table 220 corresponds to the reagent rack 1a or 2a illustrated in FIG. 2.

The reagent cover 211 is a lid configured to cover an opening of the casing 210. The reagent cover 211 is provided with a reagent suction port (not illustrated). The reagent suction port is a hole penetrating the reagent cover 211 and is provided at the position where a rotating trajectory of a reagent dispensing probe (the reagent dispensing probe 14 or 15 illustrated in FIG. 2) intersects a traveling trajectory of the opening part of any of the reagent containers 311.

The casing 210 has the opening part at the top end thereof and is formed to be able to house the rotating table 220 therein. The opening part of the casing 210 is covered by the reagent cover 211.

As illustrated in FIGS. 3 and 4, the rotating table 220 includes a supporting part 220a, a bottom face part 220b, and a lateral face part 220c. The rotating table 220 is a base on which the reagent containers 311 are placed. Although FIGS. 3 and 4 illustrate the example in which the reagent containers 311 are directly placed on the rotating table 220, the reagent containers 311 may be placed on a tray (a reagent rack), which is a base disposed with respect to the rotating table 220.

A rotation shaft 220a1 is provided substantially at the center of the supporting part 220a. The rotation shaft 220a1 is driven by the driving apparatus 80, so that the rotating table 220 repeatedly rotates and stops.

The bottom face part 220b is a base for moving a plurality of reagent containers 311. For example, as a result of the rotation of the rotating table 220, one of the plurality of reagent containers 311 placed on the rotating table 220 is stopped at the position directly below the reagent suction port, i.e., a reagent suction position.

The bottom face part 220b is provided with notches 220e and adjustment holes 220f forming a circulation path for the air in the reagent storage 200. For example, as illustrated in FIG. 4, the notches 220e and the adjustment holes 220f are formed in the bottom face part 220b at predetermined intervals in the circumferential direction.

For example, the notches 220e are provided in a radially outer edge part of the bottom face part 220b and are each formed to have a substantially semicircular shape. Due to these shapes, gaps for causing the air in the reagent storage 200 to circulate are formed between the notches 220e and the inner wall of the casing 210. For example, the adjustment holes 220f are formed in the bottom face part 220b so as to each have a substantially circular shape. The adjustment holes 220f formed in the bottom face part 220b form gaps for causing the air in the reagent storage 200 to circulate.

In this situation, the shapes of the notches 220e and the adjustment holes 220f are not limited to the shapes illustrated in FIG. 4 and may be any shape as long as the passing air is not biased or disturbed. Further, although FIGS. 3 and 4 illustrate the example in which the bottom face part 220b is provided with the notches 220e and the adjustment holes 220f, the bottom face part 220b may be provided with only the notches 220e or may be provided with only the adjustment holes 220f.

The supporting part 220a and the bottom face part 220b have mutually different diameters. The diameter of the supporting part 220a is smaller than the diameter of the bottom face part 220b. The lateral face part 220c is a face connecting the supporting part 220a to the bottom face part 220b and is provided so as to extend downward from the supporting part 220a.

The lateral face part 220c is provided with through holes 220d that form a circulation path for the air in the reagent storage 200. For example, the through holes 220d are formed in the lateral face part 220c so as to each have an oval shape extending upward from the bottom face part 220b side and are formed at predetermined intervals in the circumferential direction. The positions at which the through holes 220d are formed correspond to the positions of the reagent containers 311 placed on the rotating table 220. More specifically, on straight lines connecting the rotation shaft 220a1 to the notches 220e, the through holes 220d are provided, and the reagent containers 311 are placed. FIG. 4 illustrates an example in which the reagent containers 311 placed on the rotating table 220 are arranged in a triple ring formation. However, the reagent containers 311 do not necessarily have to be arranged in a triple ring formation and may be arranged in a ring formation of a single circle, double circles, and the like.

The convection partition plate 310c is a member for partitioning the space formed by the reagent cover 211 and the casing 210. For example, the convection partition plate 310c is configured to partition the space inside the reagent storage 200 formed by the reagent cover 211 and the casing 210 into a convection prevention tier 310c1 above the convection partition plate 310c and a convection tier 310c2 below the convection partition plate 310c. In the convection prevention tier 310c1, the opening parts of the reagent containers 311 are present. In the convection tier 310c2, the main bodies of the reagent containers 311 are present. In other words, the convection partition plate 310c is configured to partition the space formed by the reagent cover 211 and the casing 210 into the space in which the opening parts of the reagent containers 311 are present and the space in which the main bodies of the reagent containers 311 are present. In this situation, the convection partition plate 310c, the convection prevention tier 310c1, and the convection tier 310c2 are examples of the “partition part”, the “space in which the opening part of the reagent container is present” and the “space in which the main body of the reagent container is present”, respectively.

The height of the convection tier 310c2 is set on the basis of the height of the reagent containers 311 used as a reference. For example, the convection tier 310c2 is set so as to include, with respect to each of the reagent containers 311, the main body containing the reagent therein. With this arrangement, in the convection tier 310c2, the part of each of the reagent containers 311 that needs to be cooled is present.

The convection partition plate 310c has formed therein a plurality of projection holes 310d so that the opening parts of the reagent containers 311 placed on the rotating table 220 project toward the top face of the reagent storage 200. The positions at which the projection holes 310d are formed correspond to placement positions of the reagent containers 311 set on the rotating table 220. The shapes of the projection holes 310d correspond to the shapes of lateral face parts of the reagent containers 311.

For example, the cooling element 230 is provided on the bottom face of the casing 210. The controlling function 32 of the processing apparatus 90 is configured to control the driving apparatus 80 so as to bring the cooling element 230 into operation. By being driven by the driving apparatus 80, the cooling element 230 is configured to cool the reagent storage 200. For example, the cooling element 230 may be a Peltier device. In the present example, the cooling element 230 is an example of the “cooling unit”.

For example, the fan 241 is provided so as to surround the rotation shaft 220a1 of the rotating table 220. For example, the fan 242 is a fan for horizontal circulation and is provided below the bottom face part 220b of the rotating table 220. The controlling function 32 of the processing apparatus 90 is configured to control the driving apparatus 80 so as to bring the fans 241 and 242 into operation. By being driven by the driving apparatus 80, the fans 241 and 242 are configured to circulate the air in the casing 210, so that the inside of the casing 210 of the reagent storage 200 is cooled by the cooling element 230. In particular, the fans 241 and 242 are configured to circulate the air in the convection tier 310c2. The fans 241 and 242 are provided so as to send the air in the space defined by the lateral face part 220c and the supporting part 220a, toward the bottom face of the casing 210 of the reagent storage 200. With these arrangements, convection occurs in the convection tier 310c2 positioned below the convection partition plate 310c.

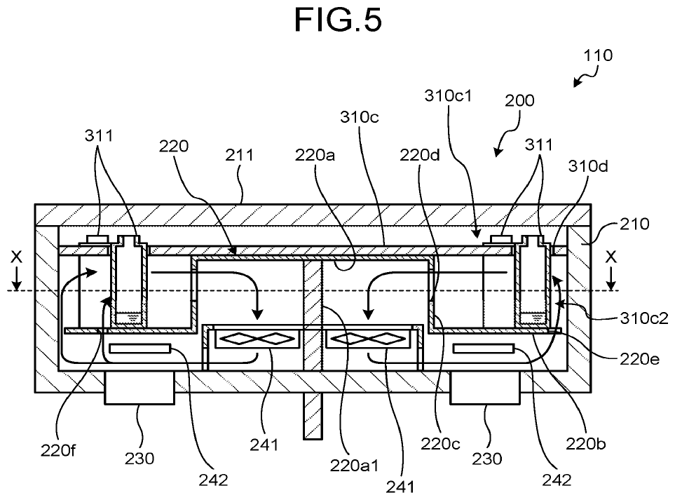

Next, the convection occurring in the reagent storage 200 will be explained. FIG. 5 is a drawing illustrating an example of a circulation path for the air in the reagent storage 200 in FIG. 3.

To circulate air in the reagent storage 200 in which the reagent containers 311 are placed, to begin with, due to the rotation of the fans 241 and 242, the air in the rotating table 220 is aspirated by the fans 241 and 242. The aspirated air is sent to the space formed between the bottom face part 220b of the rotating table 220 and the bottom face part of the casing 210. Subsequently, the air that has been sent into the space between the bottom face part 220b of the rotating table 220 and the bottom face part of the casing 210 is cooled by the cooling element 230. After that, the air that has been sent into the space is routed through the gaps between the notches 220e formed in the bottom face part 220b of the rotating table 220 and the inner wall of the casing 210 and through the adjustment holes 220f formed in the bottom face part 220b, so as to be sent into the convection tier 310c2, which is the space between the convection partition plate 310c and the bottom face part 220b. In this situation, the air that was sent into the convection tier 310c2 is routed through the through holes 220d formed in the lateral face part 220c of the rotating table 220 and is sent into the rotating table 220. In contrast, as for the convection prevention tier 310c1, which is the space between the reagent cover 211 and the convection partition plate 310c, air from the convection tier 310c2 is prevented from flowing in by the convection partition plate 310c.

As explained herein, in the reagent storing system 110 according to the present embodiment, in the reagent storage 200, the convection partition plate 310c is provided so as to partition the space inside the reagent storage 200 formed by the reagent cover 211 and the casing 210, into the convection prevention tier 310c1 which is the space in which the opening parts of the reagent containers 311 are present and the convection tier 310c2 which is the space in which the main bodies of the reagent containers 311 are present. Thus, air is prevented from flowing in to the opening parts of the reagent containers 311.

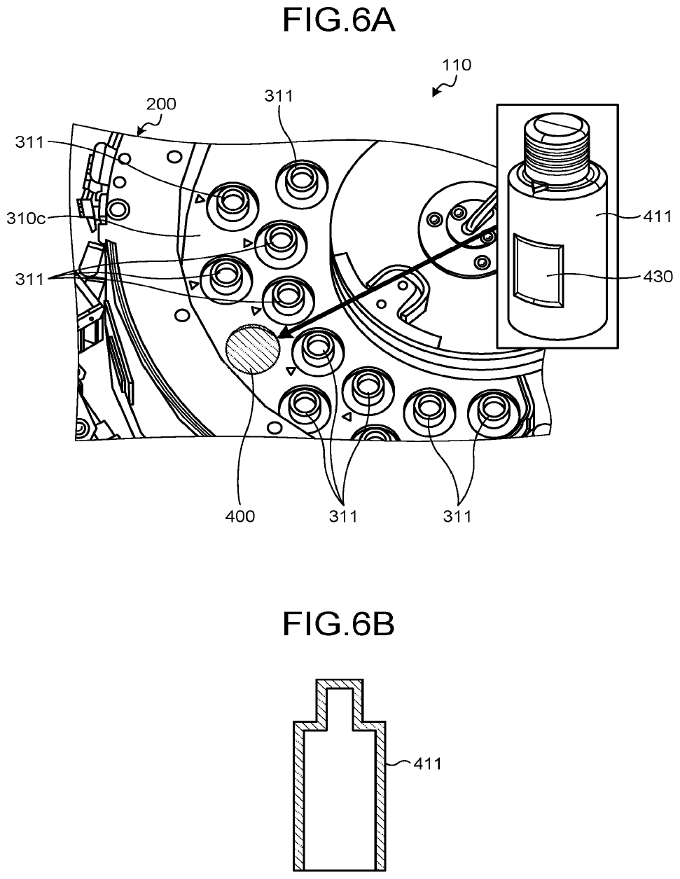

As illustrated in FIGS. 6A and 6B, the reagent storing system 110 according to the present embodiment further includes a vacant position cap 411. FIGS. 6A and 6B are schematic drawings illustrating an example of the vacant position cap 411 in the reagent storing system 110 according to the present embodiment. FIG. 6A is a perspective view of the vacant position cap 411. FIG. 6B is a cross-sectional view of the vacant position cap 411. Further, FIG. 6A illustrates the example in which the reagent containers 311 placed on the rotating table 220 are arranged in a double ring formation.

As illustrated in FIG. 6A, in the reagent storage 200, among the placement positions of the reagent containers 311 set on the rotating table 220, there may be a vacant position 400 in which no reagent container 311 is placed. In this situation, the vacant position 400 is an example of the “location where the reagent container is not placed”. In that situation, air from the convection tier 310c2 would be routed through the vacant position 400 and flow into the convection prevention tier 310c1. To cope with this situation, the vacant position cap 411 is placed in the vacant position 400, so as to thereby prevent air from flowing in to the opening parts of the reagent containers 311 through the vacant position 400. In this situation, the vacant position cap 411 is an example of the “preventing member”.

The vacant position cap 411 has the same outer shape as that of the reagent container 311. In this regard, as illustrated in FIG. 6B, the vacant position cap 411 is different from the reagent containers 311 in that no opening part is formed at the upper end, while an opening part is formed in the bottom face thereof. By having a structure without the bottom face, the vacant position cap 411 has an advantage of being easily manufactured through a resin molding process. Further, the opening part on the bottom face of the vacant position cap 411 is to be closed by the bottom face part 220b of the rotating table 220.

As explained above, in the reagent storing system 110 according to the present embodiment, in the reagent storage 200, the vacant position cap 411 having the same outer shape as that of the reagent container 311 is placed in the vacant position 400 in which no reagent container 311 is placed. As a result, air is prevented from flowing in to the opening parts of the reagent containers 311. Further, in the reagent storing system 110 according to the present embodiment, the vacant position cap 411 having the same outer shape as that of the reagent container 311 is placed in the vacant position 400 so as to cover the vacant position 400 from above. As a result, without impacting the convection in the convection tier 310c2, it is possible to circulate the cooled air within the convection tier 310c2. In the reagent storing system 110 according to the present embodiment, from the aspect of circulating the cooling-purpose airflow as designed, it is desirable when the vacant position cap 411 has the same outer shape as that of the reagent container 311.

Further, to each of the plurality of reagent containers 311 placed in the reagent storage 200, an optical label is assigned. The optical label contains identification information for identifying the reagent container 311 (a reagent bottle) and also identifying the reagent contained in the reagent container 311. The optical label is a barcode, for example.

To the vacant position cap 411, an optical label 430 is assigned. The optical label 430 contains identification information for identifying the vacant position cap 411. The optical label 430 is a dedicated barcode for identifying the vacant position cap 411, for example.

For instance, as illustrated in FIG. 2, in the automatic analyzing system 100, the analyzing apparatus 70 further includes a reading apparatus 440. The reading apparatus 440 is provided on the inner face of the casing 210 of the reagent storage 200. The controlling function 32 of the processing apparatus 90 is configured to control the driving apparatus 80 so as to bring the reading apparatus 440 into operation. By being driven by the driving apparatus 80, the reading apparatus 440 is configured to read the identification information from the optical labels of the reagent containers 311 and the vacant position cap 411 placed in the reagent storage 200. When the optical labels are barcodes, the reading apparatus 440 is a barcode reader, for example. In the present example, the reading apparatus 440 is an example of the “reading unit”.

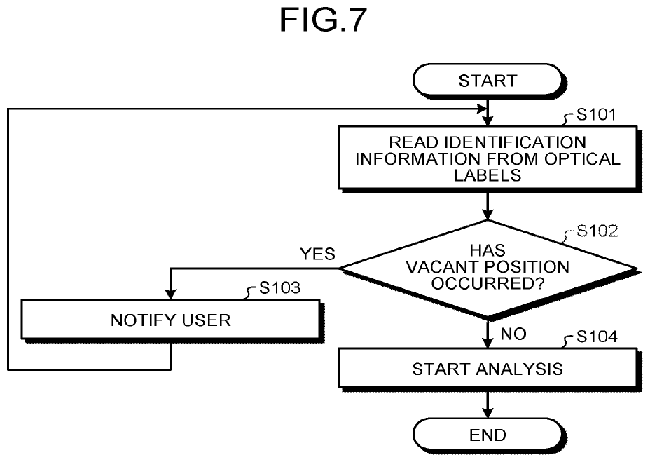

FIG. 7 is a flowchart illustrating a process performed for preventing air from flowing in through the vacant position 400, in the automatic analyzing system 100 to which the reagent storing system 110 according to the present embodiment is applied.

At step S101 in FIG. 7, before controlling the driving apparatus 80 so as to have an analysis started by the analyzing apparatus 70, the controlling function 32 of the processing apparatus 90 rotates the rotating table 220 of the reagent storage 200 and controls the reading apparatus 440 so as to read the identification information from the optical labels.

At step S102 in FIG. 7, when the reading apparatus 440 has read the optical labels, the controlling function 32 of the processing apparatus 90 judges whether or not a vacant position 400 has occurred. More specifically, on the basis of the optical labels read by the reading apparatus 440, the controlling function 32 judges whether or not the placement positions of the reagent containers 311 set on the rotating table 220 include at least one vacant position 400 where no reagent container 311 is placed. As a result of the judging process, when at least one vacant position 400 has occurred (step S102: Yes), the process in FIG. 7 proceeds to step S103. On the contrary, when no vacant position 400 has occurred (step S102: No), the process in FIG. 7 proceeds to step S104.

At step S103 in FIG. 7, the controlling function 32 of the processing apparatus 90 notifies a user, by outputting, to the output apparatus 40, information indicating that the vacant position 400 has occurred and information recommending that the vacant position cap 411 be placed in the vacant position 400. For example, the controlling function 32 notifies the user by displaying the information on a display or outputting the information as a sound. After that, the vacant position cap 411 to which the dedicated optical label 430 is assigned is placed in the vacant position 400, and the process in FIG. 7 returns to step S101.

At step S104 in FIG. 7, the controlling function 32 of the processing apparatus 90 controls the driving apparatus 80 so as to have the analysis started by the analyzing apparatus 70.

In contrast, when the reading apparatus 440 is unable to read the identification information at step S101, steps S102 and S103 are performed. In that situation, at step S103, the controlling function 32 of the processing apparatus 90 notifies the user that the identification information cannot be read, by outputting the information to the output apparatus 40. Subsequently, the optical label of the reagent container 311 is rearranged in a position readable by the reading apparatus 440, and the process in FIG. 7 returns to step S101.

As explained above, in the reagent storing system 110 according to the present embodiment, the reagent storage 200 is provided with the convection partition plate 310c configured to partition the space in the reagent storage 200 formed by the reagent cover 211 and the casing 210, into the convection prevention tier 310c1 which is the space in which the opening parts of the reagent containers 311 are present and the convection tier 310c2 which is the space in which the main bodies of the reagent containers 311 are present, so as to thereby prevent air from flowing in to the opening parts of the reagent containers 311. Further, in the reagent storing system 110 according to the present embodiment, the vacant position cap 411 having the same outer shape as that of the reagent container 311 is placed in the vacant position 400 in which no reagent container 311 is placed, so as to thereby prevent air from flowing in to the opening parts of the reagent containers 311. Consequently, when the reagent storing system 110 according to the present embodiment is used, it is possible to prevent the reagent in the reagent storage 200 from evaporating, by using the simple structure. Further, in the reagent storing system 110 according to the present embodiment, in the vacant position 400, the vacant position cap 411 having the same outer shape as that of the reagent container 311 is placed so as to cover the vacant position 400 from above. It is therefore possible to circulate the cooled air in the convection tier 310c2, without impacting the convection in the convection tier 310c2.

For example, in the automatic analyzing system 100 to which the reagent storing system 110 according to the embodiment is applied, when a vacant position 400 has occurred, the user is notified with the information recommending that the vacant position cap 411 be placed in the vacant position 400. In that situation, as a result of the user placing the vacant position cap 411 in the vacant position 400, air is prevented from flowing in to the opening parts of the reagent containers 311. Consequently, when the reagent storing system 110 according to the present embodiment is used, it is possible to prevent the reagent in the reagent storage 200 from evaporating, by using the simple structure. It is therefore possible to circulate the cooled air in the convection tier 310c2, without impacting the convection in the convection tier 310c2.

The embodiment has thus been explained; however, it is possible to carry out the present disclosure in various different modes other than those in the embodiment described above.

### First Modification Example

The above embodiment uses the example in which the plurality of reagent containers placed on the rotating table 220 have mutually the same shape; however, in another example, the plurality of reagent containers placed on the rotating table 220 may have mutually-different shapes. Thus, as a first modification example, an example will be explained in which, even when a vacant position 400 has occurred among reagent containers having mutually-different shapes, one selected from among vacant position caps having mutually-different shapes is placed in the vacant position 400 in accordance with the shape of the reagent container.

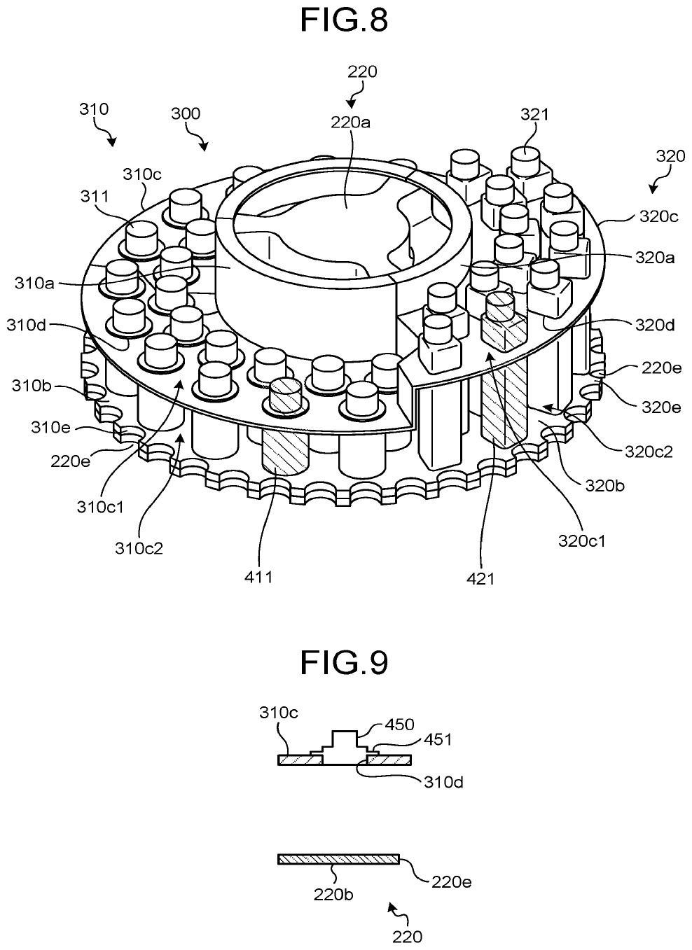

FIG. 8 is a perspective view illustrating an exemplary configuration of a tray 300 in the reagent storage 200 and examples of vacant position caps 411 and 421 in the first modification example. In FIG. 8, depiction of the casing 210, the reagent cover 211, the cooling element 230, and the fans 241 and 242 is omitted.

As illustrated in FIG. 8, the reagent storage 200 further includes the tray 300. In this situation, the bottom face part 220b of the rotating table 220 is a base on which the tray 300 is placed. On the tray 300, a plurality of reagent containers are placed. In other words, the bottom face part 220b is the base for moving the plurality of reagent containers placed on the tray 300. For example, as a result of the rotation of the rotating table 220, one of the plurality of reagent containers on the tray 300 placed on the rotating table 220 is stopped at the position directly below the reagent suction port, i.e., the reagent suction position.

The tray 300 is a base which is disposed with respect to the rotating table 220 and on which the reagent containers having mutually-different shapes due to having mutually-different capacities or designs, for example, are placed. For example, the tray 300 is divided into a plurality of partial trays 310 and 320. In the present embodiment, an example will be explained in which the quantity of types of racks is two; however, the present disclosure is not limited to this example, and the quantity may be two or more. For example, the tray 300 may be divided into three regions, so that three partial trays can be arranged in the three regions, respectively. FIG. 8 illustrates a pattern in which two partial trays 310 and one partial tray 320 are arranged. Further, possible embodiments are not limited to this pattern. Alternatively, it is also acceptable to arrange one partial tray 310 and two partial trays 320.

In the plurality of partial trays 310 and 320, a plurality of types of reagent containers 311 and 321 having mutually-different shapes are placed, respectively. For example, in the plurality of partial trays 310 and 320, the reagent containers 311 and 321 having mutually-different heights are placed. For example, let us assume that the height of each of the reagent containers 311 is shorter than the height of each of the reagent containers 321.

As illustrated in FIG. 8, the partial trays 310 each include a lateral face part 310a, a bottom face part 310b, and a convection partition plate 310c. The bottom face part 310b is a base on which the reagent containers 311 are placed. On the bottom face part 310b, the plurality of reagent containers 311 are placed. In other words, the bottom face part 310b is the base for moving the plurality of reagent containers 311. The bottom face part 310b is provided with notches 310e and adjustment holes that form a circulation path for the air in the reagent storage 200. For example, the notches 310e and the adjustment holes are formed in the bottom face part 310b at predetermined intervals in the circumferential direction. The positions at which the notches 310e and the adjustment holes are formed correspond to the positions of the notches 220e and the adjustment holes 220f formed in the rotating table 220, respectively.

The lateral face parts 310a are each provided so as to extend toward the bottom face part 310b and so as to be in close contact with and to cover the lateral face part 220c of the rotating table 220. When the partial trays 310 have been attached to the rotating table 220, the bottom face parts 310b of the partial trays 310 are provided over the bottom face part 220b of the rotating table 220. The lateral face part 220c of the rotating table 220 is provided so as to be positioned adjacent to the lateral face parts 310a of the partial trays 310. The lateral face parts 310a are provided with through holes that form a circulation path for the air in the reagent storage 200. For example, the through holes in the lateral face parts 310a are formed in the lateral face parts 310a so as to each have an oval shape extending upward from the bottom face part 310b side and are formed at predetermined intervals in the circumferential direction. The positions at which the through holes in the lateral face parts 310a are formed correspond to the positions of the through holes 220d formed in the lateral face part 220c of the rotating table 220. In other words, the through holes in the lateral face parts 310a form the circulation path for the air in the reagent storage 200, as a result of being formed so as to communicate with the through holes 220d. The shapes of the through holes in the lateral face parts 310a are determined on the basis of the shapes of the reagent containers 311 arranged on the partial trays 310. For example, the dimension, in terms of the height direction, of the through holes in the lateral face parts 310a is smaller than the dimension, in terms of the height direction, of the through holes 220d formed in the lateral face part 220c of the rotating table 220.

For example, the convection partition plates 310c are each fixed to the lateral face part 310a. The convection partition plates 310c have each formed therein projection holes 310d so that the opening parts of the reagent containers 311 placed on the partial trays 310 project toward the top face of the reagent storage 200. The opening parts of the reagent containers 311 are extraction ports through which the reagent is extracted from the reagent containers 311. The positions at which the projection holes 310d are formed correspond to the positions of the reagent containers 311 arranged on the partial trays 310. The shapes of the projection holes 310d formed in the convection partition plates 310c correspond to the shapes of the reagent containers 311 arranged on the partial trays 310. For example, when the reagent containers 311 arranged on the partial trays 310 each have a circular cylindrical shape, each of the projection holes 310d formed in the convection partition plates 310c has a circular shape. As explained herein, the partial trays 310 have formed therewith a storing space in which the reagent containers 311 are inserted through the projection holes 310d in the convection partition plates 310c, while being arranged on the bottom face parts 310b. The storing space of the partial trays 310 is the part in which the reagent containers 311 are placed. For example, the partial trays 310 are each structured so that a placement part on which the reagent containers 311 are placed is integrally formed with the through holes in the lateral face part 310a.

The convection partition plates 310c are each a member for partitioning the space formed by the reagent cover 211 and the casing 210. The space formed by the reagent cover 211, the casing 210, and each of the convection partition plates 310c is partitioned, for example, into the convection prevention tier 310c1 which is the space above the convection partition plate 310c and the convection tier 310c2 which is the space below the convection partition plate 310c. The position in which the convection partition plate 310c is fixed to the lateral face part 310a is set on the basis of the height of the reagent containers 311 used as a reference. For example, the convection tier 310c2 is set so as to include, of the entirety of each reagent container 311, the main body part containing the reagent. As explained herein, because the convection partition plates 310c are provided, the cooled air circulates around the main body parts of the reagent containers 311 in the convection tier 310c2, whereas air does not circulate around the opening parts of the reagent containers 311 in the convection prevention tier 310c1. In other words, the convection partition plates 310c are configured to prevent air from flowing in to the opening parts of the reagent containers 311.

Further, in the first modification example, when a vacant position 400 has occurred among the reagent containers 311 arranged on the partial trays 310, the vacant position cap 411 having a circular cylindrical shape which is the same outer shape as that of the reagent container 311 is placed in the vacant position 400. The vacant position cap 411 has no opening part formed at the upper end, while an opening part is formed in the bottom face thereof.

As illustrated in FIG. 8, the partial tray 320 includes a lateral face part 320a, a bottom face part 320b, and a convection partition plate 320c. The bottom face part 320b is a base on which the reagent containers 321 are placed. On the bottom face part 320b, the plurality of reagent containers 321 are placed. In other words, the bottom face part 320b is the base for moving the plurality of reagent containers 321. The bottom face part 320b is provided with notches 320e and adjustment holes that form a circulation path for the air in the reagent storage 200. For example, as illustrated in FIG. 8, the notches 320e and the adjustment holes are formed in the bottom face part 320b at predetermined intervals in the circumferential direction. The positions at which the notches 320e and the adjustment holes are formed correspond to the positions of the notches 220e and the adjustment holes 220f, respectively.

The lateral face part 320a is provided so as to extend toward the bottom face part 320b and so as to be in close contact with and to cover the lateral face part 220c of the rotating table 220. When the partial tray 320 has been attached to the rotating table 220, the bottom face part 320b of the partial tray 320 is provided over the bottom face part 220b of the rotating table 220. The lateral face part 220c of the rotating table 220 is provided so as to be positioned adjacent to the lateral face part 320a of the partial tray 320. The lateral face part 320a is provided with through holes that form a circulation path for the air in the reagent storage 200. For example, the through holes in the lateral face part 320a are formed in the lateral face part 320a so as to each have an oval shape extending upward from the bottom face part 320b side and are formed at predetermined intervals in the circumferential direction. The positions at which the through holes in the lateral face part 320a are formed correspond to the positions of the through holes 220d formed in the lateral face part 220c of the rotating table 220. In other words, the through holes in the lateral face part 320a form the circulation path for the air in the reagent storage 200, as a result of being formed so as to communicate with the through holes 220d. The shapes of the through holes in the lateral face part 320a are determined on the basis of the shapes of the reagent containers 321 arranged on the partial tray 320. For example, the dimension, in terms of the height direction, of the through holes in the lateral face part 320a is equal to the dimension, in terms of the height direction, of the through holes 220d formed in the lateral face part 220c of the rotating table 220.

For example, the convection partition plate 320c is fixed to the lateral face part 320a. The convection partition plate 320c has formed therein projection holes 320d so that the opening parts of the reagent containers 321 placed on the partial tray 320 project toward the top face of the reagent storage 200. The opening parts of the reagent containers 321 are extraction ports through which the reagent is extracted from the reagent containers 321. The positions at which the projection holes 320d are formed correspond to the positions of the reagent containers 321 arranged on the partial tray 320. The shapes of the projection holes 320d formed in the convection partition plate 320c correspond to the shapes of the reagent containers 321 arranged on the partial tray 320. For example, when the reagent containers 321 arranged on the partial tray 320 each have a rectangular cylindrical shape, each of the projection holes 320d formed in the convection partition plate 320c has a rectangular shape. As explained herein, the partial tray 320 has formed therewith a storing space in which the reagent containers 321 are inserted through the projection holes 320d in the convection partition plate 320c, while being arranged on the bottom face part 320b. The storing space of the partial tray 320 is the part in which the reagent containers 321 are placed. For example, the partial tray 320 is structured so that a placement part on which the reagent containers 321 are placed is integrally formed with the through holes in the lateral face part 320a.

The convection partition plate 320c is a member for partitioning the space formed by the reagent cover 211 and the casing 210. The space formed by the reagent cover 211, the casing 210, and the convection partition plate 320c is partitioned, for example, into a convection prevention tier 320c1 which is the space above the convection partition plate 320c and a convection tier 320c2 which is the space below the convection partition plate 320c. The position in which the convection partition plate 320c is fixed to the lateral face part 320a is set on the basis of the height of the reagent containers 321 used as a reference. For example, the convection tier 320c2 is set so as to include, of the entirety of each reagent containers 321, the main body part containing the reagent. As explained herein, because the convection partition plate 320c is provided, the cooled air circulates around the main body parts of the reagent containers 321 in the convection tier 320c2, whereas air does not circulate around the opening parts of the reagent containers 321 in the convection prevention tier 320c1. In other words, the convection partition plate 320c is configured to prevent air from flowing in to the opening parts of the reagent containers 321.

Further, in the first modification example, when a vacant position 400 has occurred among the reagent containers 321 arranged on the partial tray 320, the vacant position cap 421 having the rectangular cylindrical shape which is the same outer shape as that of the reagent container 321 is placed in the vacant position 400. The vacant position cap 421 has no opening part formed at the upper end, while an opening part is formed in the bottom face thereof.

As explained above, in the first modification example, when the vacant position 400 has occurred among the reagent containers 311 arranged on the partial trays 310, the vacant position cap 411 having the circular cylindrical shape which is the same outer shape as that of the reagent container 311 is placed in the vacant position 400, so as to thereby prevent air from flowing in to the opening parts of the reagent containers 311. As another example, in the first modification example, when the vacant position 400 has occurred among the reagent containers 321 arranged on the partial tray 320, the vacant position cap 421 having the rectangular cylindrical shape which is the same outer shape as that of the reagent container 321 is placed in the vacant position 400, so as to thereby prevent air from flowing in to the opening parts of the reagent containers 321. Consequently, in the first modification example, even when the vacant positions 400 have occurred among the reagent containers 311 and 321 having the mutually-different shapes, the vacant position caps 411 and 421 respectively corresponding to the shapes of the reagent containers 311 and 321 are placed in the vacant positions 400. It is therefore possible to prevent the reagent in the reagent storage 200 from evaporating, by using the simple structure.

Further, in the first modification example, by placing the vacant position cap 411 having the same outer shape as that of the reagent container 311 in the vacant position 400, it is possible to circulate the cooled air in the convection tier 310c2, without impacting the convection in the convection tier 310c2. Furthermore, in the first modification example, by placing the vacant position cap 421 having the same outer shape as that of the reagent container 321, it is possible to circulate the cooled air in the convection tier 310c2, without impacting the convection in the convection tier 320c2.

### Second Modification Example

In the embodiment described above, the vacant position cap 411 is shaped so as to extend to the bottom face part similarly to the reagent containers 311. In the first modification example, the vacant position caps 411 and 421 are each shaped so as to extend to the bottom face part similarly to the reagent containers 311 and 321, respectively. However, possible embodiments are not limited to these examples.

FIG. 9 is a schematic drawing illustrating an example of a vacant position cap 450 in the reagent storage 200 in a second modification example.

The vacant position cap 450 has no opening part formed at the upper end, while an opening part is formed in the bottom face thereof. In this situation, the bottom face of the vacant position cap 450 is not shaped so as to extend to the bottom face part unlike the reagent containers. For example, the vacant position cap 450 is provided with a flange 451 on the lateral face thereof and is shaped in such a manner that, while the lateral face of the vacant position cap 450 is fitted in the projection hole 310d in the convection partition plate 310c, the vacant position cap 450 is placed on the convection partition plate 310c by the flange 451.

In this situation, the shape of the lateral face of the vacant position cap 450 is a circular cylindrical shape when being the same as the shape of the lateral face of each of the reagent containers 311 and is a rectangular cylindrical shape when being the same as the shape of the lateral face of each of the reagent containers 321.

As explained above, in the second modification example, when a vacant position 400 has occurred, by fitting the vacant position cap 450 into the vacant position 400, air is prevented from flowing in to the opening parts of the reagent containers. Consequently, according to the second modification example, it is possible to prevent the reagent in the reagent storage 200 from evaporating, by using the simple structure. However, from the aspect of circulating the cooling-purpose airflow as designed, it is desirable when the vacant position cap has the same outer shape as that of the reagent containers 311.

### Third Modification Example

In the embodiment, the first modification example, and the second modification example described above, when a vacant position 400 has occurred, the vacant position cap is provided in the vacant position 400; however, possible embodiments are not limited to this example. In a third modification example, an example in which no vacant position cap is provided will be explained.

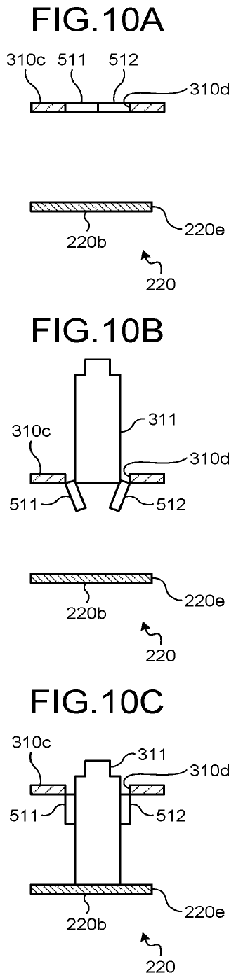

FIGS. 10A to 10C are schematic drawings illustrating an exemplary configuration for preventing air from flowing in through the vacant position 400 in the third modification example.

As illustrated in FIG. 10A, the projection hole 310d in the convection partition plate 310c is provided with covers 511 and 512 for covering the opening in the convection partition plate 310c. For example, the covers 511 and 512 and the projection hole 310d are provided with springs, so that the covers 511 and 512 cover the opening in the convection partition plate 310c with biasing force of the springs. In this situation, as illustrated in FIG. 10B, at the time of placing the reagent container 311, as a result of pressing the covers 511 and 512 downward with the bottom part of the reagent container 311, the biasing force of the springs is cancelled, so that the reagent container 311 is placed as illustrated in FIG. 10C.

Further, when the position illustrated in FIG. 10C serves as a vacant position 400, the reagent container 311 is taken out of the placement position of the reagent container 311 in the sequential order of FIG. 10C, FIG. 10B, and FIG. 10A, so that the opening in that position is covered by the covers 511 and 512.

The top faces of the covers 511 and 512 are shaped so that a circle is formed by the cover 511 and the cover 512 when having the same shape as that of the lateral face of each of the reagent containers 311 and are shaped so that a rectangle is formed by the cover 511 and the cover 512 when having the same shape as that of the lateral face of each of the reagent containers 321.

As explained above, in the third modification example, by providing the convection partition plate 310c with the covers 511 and 512 capable of opening and closing, air is prevented from flowing in to the opening parts of the reagent containers 311. Consequently, in the third modification example, it is possible to prevent the reagent in the reagent storage 200 from evaporating, by using the simple structure. Further, in the third modification example, without the need to provide the vacant position cap, it is possible to let a vacant position 400 occur.

According to at least one aspect of the embodiments described above, it is possible to prevent the reagent in the reagent storage from evaporating, by using the simple structure.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A reagent storing system comprising:
a reagent storage including a rotating table on which a reagent container is placed, a casing formed to be able to house the rotating table therein, a cover configured to cover an opening of the casing, a cooling unit, a fan configured to circulate air in the casing so that an inside of the casing is cooled by the cooling unit, and a partition part configured to partition a space formed by the cover and the casing into a space in which an opening part of the reagent container is present and a space in which a main body of the reagent container is present; and
a preventing member configured, while being placed in a location where the reagent container is not placed, to prevent the air from flowing in to the opening part of the reagent container through the location.

2. The reagent storing system according to claim 1, wherein the preventing member has a same outer shape as that of the reagent container.

3. The reagent storing system according to claim 1, wherein the preventing member is configured to cover the location from above.

4. The reagent storing system according to claim 1, further comprising:
a tray that serves as a base disposed with respect to the rotating table and includes a plurality of partial trays respectively having installed thereon reagent containers including the reagent container that have mutually-different shapes, wherein
a shape of the preventing member varies in accordance with the shapes of the reagent containers.

5. An automatic analyzing system comprising:
a reagent storage including a rotating table on which a reagent container is placed, a casing formed to be able to house the rotating table therein, a cover configured to cover an opening of the casing, a cooling unit, a fan configured to circulate air in the casing so that an inside of the casing is cooled by the cooling unit, and a partition part configured to partition a space formed by the cover and the casing into a space in which an opening part of the reagent container is present and a space in which a main body of the reagent container is present;
an analyzing apparatus configured to dispense a specimen and a reagent from the reagent container stored in the reagent storage into a reaction container and to generate analysis data by performing a measuring process on a mixture of the specimen and the reagent in the reaction container; and
a preventing member configured, while being placed in a location where the reagent container is not placed, to prevent the air from flowing in to the opening part of the reagent container through the location.

6. The automatic analyzing system according to claim 5, further comprising:
processing circuitry configured to judge whether or not the location has occurred; and
an output apparatus configured, when the location has occurred, to output information recommending that the preventing member be placed in the location.

7. The automatic analyzing system according to claim 6, further comprising:
optical labels that are assigned to the reagent container and to the preventing member and that contain identification information for identifying the reagent container and the preventing member, respectively; and
a reading unit configured to read the identification information from the optical labels, wherein
the processing circuitry is configured to judge whether or not the location has occurred on a basis of the optical labels read by the reading unit.

8. The automatic analyzing system according to claim 7, wherein the processing circuitry is configured to rotate the rotating table and to control the reading unit so as to read the identification information from the optical labels.

9. A preventing member to be applied to a reagent storage including a rotating table on which a reagent container is placed, a casing formed to be able to house the rotating table therein, a cover configured to cover an opening of the casing, a cooling unit, a fan configured to circulate air in the casing so that an inside of the casing is cooled by the cooling unit, and a partition part configured to partition a space formed by the cover and the casing into a space in which an opening part of the reagent container is present and a space in which a main body of the reagent container is present, wherein
while being placed in a location where the reagent container is not placed, the preventing member is configured to prevent the air from flowing in to the opening part of the reagent container through the location.
